(19) United States
(12) Patent Application Publication
(10) Pub. No.: US 2018/0084070 A1
(43) Pub. Date: Mar. 22, 2018

(54) MEDIA CONTENT FILTERING USING LOCAL PROFILE AND RULES

(71) Applicant: International Business Machines Coporation, Armonk, NY (US)

(72) Inventors: Mamnoon Jamil, Voorhees, NJ (US); Grant D. Miller, Arvada, CO (US); Cheranellore Vasudevan, Bastrop, TX (US); Jian Wu, Mansfield, TX (US)

(21) Appl. No.: 15/272,567

(22) Filed: Sep. 22, 2016

(51) Int. Cl. H04L 29/08; H04L 29/06

(52) U.S. Cl. CPC H04L 67/26; H04L 65/60; H04L 67/22; H04L 67/306

(57) ABSTRACT

A system and method of media content acquisition and filtering are provided. The method includes setting a user profile, user selections, and user preferences locally at a receiving end based on at least one user input, receiving media content at the receiving end from a broadcast server, and processing, using an analytics model, one or more of the user preferences, the user selections, and analytics generated using the user profile and user preferences using a learning capability of the analytics model, filtering the media content at the receiving end based on one or more of user ID logic, the user profile, the user preferences, the user selections, and analytics generated using the user profile and user preferences.

### BACKGROUND

The subject matter disclosed herein generally relates to content filtering and, more particularly, to broadcast media content filtering.

The phrase “profile-based content pushing” is used in the media industry to describe a method of delivering media content, wherein, for example, a media provider collects information about the user and stores that information in user profiles at a remote location. The media provider then processes this collected information and uses it to determine the media content that is “pushed” to the user. The collected information can include information and settings directly provided by the user or can include indirectly collected information such as usage history and browsing information in addition to time of day and content type watched.

### SUMMARY

According to one or more embodiments a method of media content acquisition and filtering is provided. The method includes setting a user profile, user selections, and user preferences locally at a receiving end based on at least one user input. The method also includes receiving media content at the receiving end from a broadcast server, and processing, using an analytics model, one or more of the user preferences, the user selections, and analytics generated using the user profile and user preferences using a learning capability of the analytics model. The method also includes filtering the media content at the receiving end based on one or more of user ID logic, the user profile, the user preferences, the user selections, and analytics generated using the user profile and user preferences.

According to one or more embodiments a system for media content acquisition and filtering is provided. The system includes a memory having computer readable instructions, and a processor configured to execute the computer readable instructions, the computer readable instructions including setting a user profile, user selections, and user preferences locally at a receiving end based on at least one user input, receiving media content at the receiving end from a broadcast server, and filtering the media content at the receiving end based on one or more of user ID logic, the user profile, the user preferences, the user selections, and analytics generated using the user profile and user preferences.

According to one or more embodiments a computer program product for media content acquisition and filtering is provided. The computer program product including a computer readable storage medium having program instructions embodied therewith, the program instructions executable by a processor to cause the processor to set a user profile, user selections, and user preferences locally at a receiving end based on at least one user input, receive media content at the receiving end from a broadcast server, and filter the media content at the receiving end based on one or more of user ID logic, the user profile, the user preferences, the user selections, and analytics generated using the user profile and user preferences.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 is a block diagram of a networked system for enabling communication between devices that make up the networked system for practice of the teachings herein in accordance with one or more embodiments;

FIG. 2 is a block diagram illustrating one example of a device, such as a host system, user system, and/or storage device as shown in FIG. 1, for practice of the teachings herein in accordance with one or more embodiments;

FIG. 3 is a block diagram of a system for implementing a method of media content acquisition and filtering in accordance with one or more embodiments; and

FIG. 4 is a block diagram of a method of filtering media content in accordance with one or more embodiments.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc., as will be appreciated by those of skill in the art, whether explicitly described or otherwise would be appreciated by those of skill in the art.

As previously noted herein, “profile-based content pushing” is known generally as a method of delivering media content, wherein, for example, a media provider collects information about the user and stores that information in user profiles at a remote location. The media provider then processes this collected information and uses it to determine the media content that is “pushed” to the user. The collected information can include information and settings directly provided by the user or can include indirectly collected information such as usage history and browsing information in addition to time of day and content type watched.

The remote media provider can perform selective pushing from a server, which is on the content source side of the media transmission network. This remote based system may entail privacy intrusion because the user profiles and all the associated information are stored in an external server/repository. Additionally, the remote nature of the arrangement means that any conductivity outage also disconnects a user from not only the media content but their user specification information.

Embodiments described herein are directed to a method and system for locally filtering media content received from a networked source based on locally stored and collected information about and from a user. Further, one or more embodiments are directed to requesting, or pulling, media based on locally stored user information that can include user setting, preferences, usage information, browsing information, search request tracking, or any combination thereof. Further, one or more embodiments provide dynamic feedback to an analytics module, which has an associated learning mechanism. This feedback and learning feature of the analytics model helps provide the local filtering of media content.

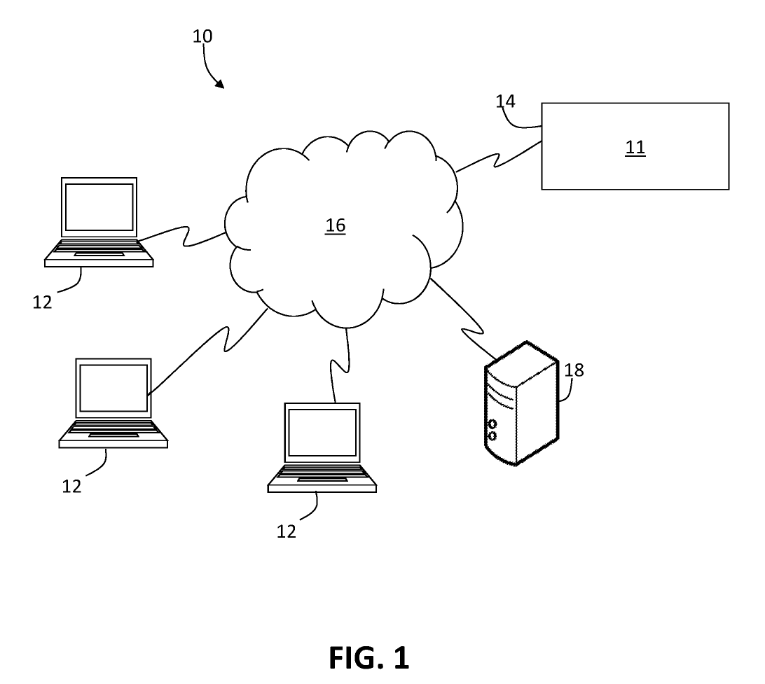

Turning now to FIG. 1, a block diagram of a networked system 10 for enabling communication between devices that make up the networked system 10 for practice of the teachings herein is shown in accordance with one or more embodiments. The system 10 includes channel control application, hereinafter channel control system 11, for performing the processing described herein that is executed by one or more computer programs located on a host system 14 and/or a user system(s) 12.

The system 10 depicted in FIG. 1 includes one or more user systems 12 through which users and other persons, at one or more geographic locations may contact the host system 14 to initiate programs and/or participate in the channel control system 11. The user systems 12 are coupled to the host system 14 via a network 16. Each user system 12 may be implemented using a general-purpose computer executing a computer program for carrying out the processes described herein. According to another embodiment, the user system 12 can be a digital video recording device, a television with integrated computing devices, a set-top box, and/or a combination thereof. Further, the user systems 12 may be user devices such as personal computers (e.g., a laptop, a tablet computer, a cellular telephone, etc.) or host attached terminals. If the user systems 12 are personal computers, in some embodiments, the processing described herein may be shared by a user system 12 and the host system 14. The user systems 12 may also include game consoles, network management devices, and field programmable gate arrays. In addition, multiple user systems 12 and/or host systems 14 may be concurrently operating.

The network 16 may be any type of known network including, but not limited to, a wide area network (WAN), a local area network (LAN), a global network (e.g. Internet), a virtual private network (VPN), a cloud network, and an intranet. The network 16 may be implemented using a wireless network or any kind of physical network implementation known in the art. A user system 12 may be coupled to the host system through multiple networks 16 (e.g., cellular and Internet) so that not all user systems 12 are coupled to the host system 14 through the same network 16. One or more of the user systems 12 and the host system 14 may be connected to the network 16 in a wireless fashion. In one non-limiting embodiment, the network is the Internet and one or more user systems 12 execute a user interface application (e.g., a web browser) to contact the host system 14 through the network 16. In another non-limiting example embodiment, the user system 12 is connected directly (i.e., not through the network 106) to the host system 14. In a further non-limiting embodiment, the host system 14 is connected directly to or contains a storage device 18. The network 16 may be employed by the channel control system 11 such that the channel control system 11 may communicate with one or more resources, either directly or indirectly.

The storage device 18 includes data relating to the channel control system 11 and/or data relating to data channel control and generation. In some embodiments, the storage device 18 may be implemented using a variety of devices for storing electronic information. In an example embodiment, data stored in the storage device 18 includes, but is not limited to, channel properties and functionality, and other data utilized by embodiments described herein such as broadcast media content. It is understood that the storage device 18 may be implemented using memory contained in the host system 14 or that it may be a separate physical device. The storage device 18 may be logically addressable as a consolidated data source across a distributed environment that includes the network 16. Information stored in the storage device 18 may be retrieved and manipulated via the host system 14 and/or via a user system 12.

The host system 14 depicted in FIG. 1 may be implemented using one or more servers operating in response to a computer program stored in a storage medium accessible by the server. The host system 14 may operate as a network server (e.g., a web server) to communicate with the user system 12. The host system 14 handles sending and receiving information to and from the user system 12 using the defined channels and can perform associated tasks. The host system 14 may also include a firewall to prevent unauthorized access to the host system 14 and enforce any limitations on authorized access, e.g., permitting only designated SMEs and/or other authorized persons to access the channel control system 11. For instance, an administrator may have access to the entire system and have authority to modify portions of the system and/or permissions thereto. A firewall may be implemented using conventional hardware and/or software as is known in the art.

The host system 14 may also operate as an application server. The host system 14, in such embodiments, may execute one or more computer programs, including the channel control system 11, to provide aspects of embodiments as described herein. Processing may be shared by the user system 12 and the host system 14 by providing an application to the user system 12. Alternatively, the user system 12 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

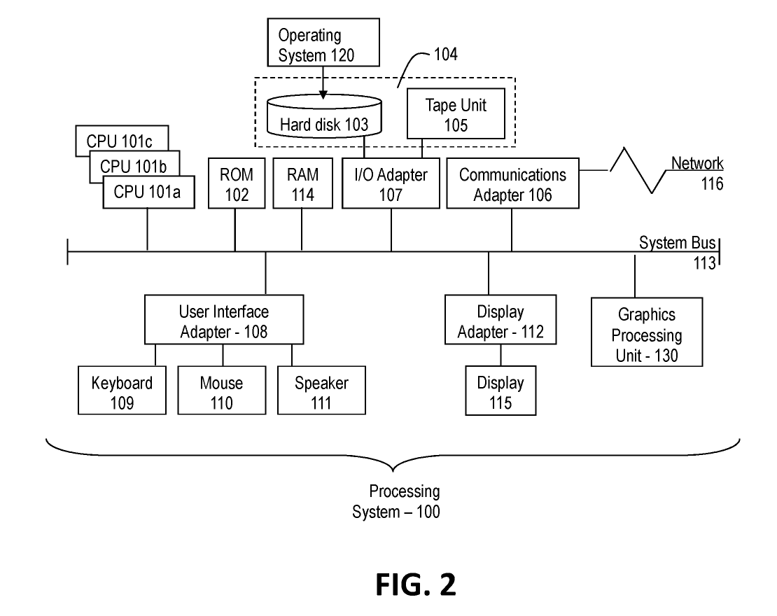

Turning to FIG. 2, a block diagram illustrating one example of a device 100, such as a host system 14, user system 12, and/or storage device 18 as shown in FIG. 1, for practice of the teachings herein is shown in accordance with one or more embodiments. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 2 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 2, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 2.

According to an embodiment, a method and/or system are provided that includes preference based filtering at a receiving end rather than profiling server-side. These preferences are set using a set of context specific rules. Further, in this embodiment a user has control rather than a remote provider deciding and controlling.

For example, according to an embodiment, content filtering is provided at the receiving end based on a user profile set locally. This method includes setting local preferences and logic that uses the preferences to filter the broadcast media content down to that which is desired by the user. Also, according to an embodiment, the preferences can be expressed as a set of context sensitive rules that are stored locally at a receiving end. Accordingly, a remote server/provider has no control over decision making. All channels/program are streamed/broadcast and the filtering happens at the receiver end.

According to one or more embodiments, a filtering can also provide “selective pulling” of desired content based on profile/preferences stored locally at the receiving end. This method and system is different from, for example an RSS feeds where one only pulls the needed items, in that the embodiment receives every channel/media/blog/twitter etc., and then selectively pulls the content based on the user input. Specifically, the method then filters based on the tags and conditions that a user has set or according to a policy-based filtering provided by the user.

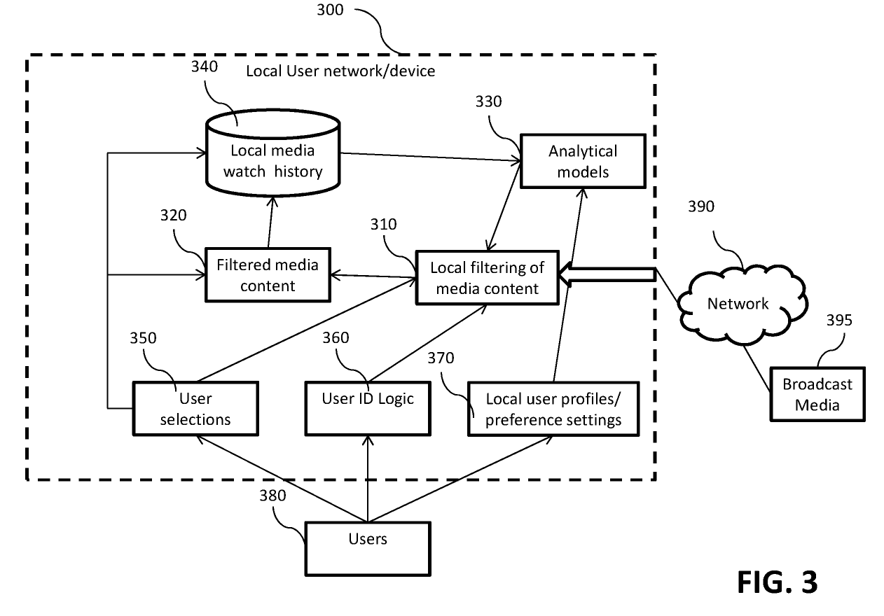

For example, turning now to FIG. 3, a block diagram of a system for implementing a method of media content acquisition and filtering is provided in accordance with one or more embodiments. As shown a local user network 300 is shown which is also known as the receiving side of the overall media system. The local user network 300 can include a number of devices located, for example, in a user's home such as set-top boxes, televisions, a stereo devise, home computers, tablets, and mobile devices among other electronics that could also be envisioned for handling media content. Alternatively, according to another embodiment, the local user network 300 can be a single local user device 300 that is able to provide all the elements for implementing a method of media content filtering and acquisition.

Looking specifically at the elements for implementing a method of media content filtering and acquisition, in accordance with one or more embodiments, the receiving end 300 includes a number of user defined values that are used to implement the filtering. For example, the local user network/device 300 includes user selections 350. The user selections 350 can include user inputs that include commands for specific media content in accordance with one or more embodiments. The local user network device 300 also includes user ID logic 360. Further, the local user network device 300 includes local user profiles and preference settings 370. These values are all based on user input(s) that can be provided in real-time or over a period of time.

Further, the local user network device 300 includes one or more processing elements in accordance with one or more embodiments. For example, the receiving end 300 includes one or more analytical models 330 that can provide filtering guidance based on processing user generated information. For example, the one or more analytical models 300 can include a model that provides a predictive media signal that contains information defining media content that should remain included when filtering. The predictive media signal can be calculated based on, for example, one or more of historical usage data 340 of media watched by the user, the user profile, and/or the preferences setting of the user 370.

The receiving end 300 also has local filtering of received media content 310 that is based on the predictive media signal provided by the analytical model 330. According to one or more embodiments, a “learning capability” of the analytical model is also provided. For example, the analytical model 330 can utilize “predictive models” to learn from historical data, refine and update user profiles and user preferences over time. Further, the analytical model incrementally learns and updates the local filter parameters. For example, a filter in accordance with one or more embodiments can be driven by the context such as time of the day, day of the week, etc., for media streaming or TV streaming for example. Further, the filtering is governed by dynamic content analytics as opposed to using the metadata of the content. Further, the analytical model 330 can implement dynamic feedback and associated learning mechanism. According to one or more embodiments, the analytical model may be implemented as a machine learning device (e.g., an artificial neural network).

Additionally, the filtering can be based on user ID logic 360 and/or user selections 350. This filtered media content 320 are then provided to a user for viewing or storage. Further, information about the filtered media content 320 can be stored in the local media watch history 340 for later use when calculating using analytical models 330 as described above. Also, as shown, the broadcast media 395 is provided to the receiving side 300 through a network 390. The network 390 is similar to the network as shown in FIG. 1 that can be used to connect the receiving side to a remote content provider.

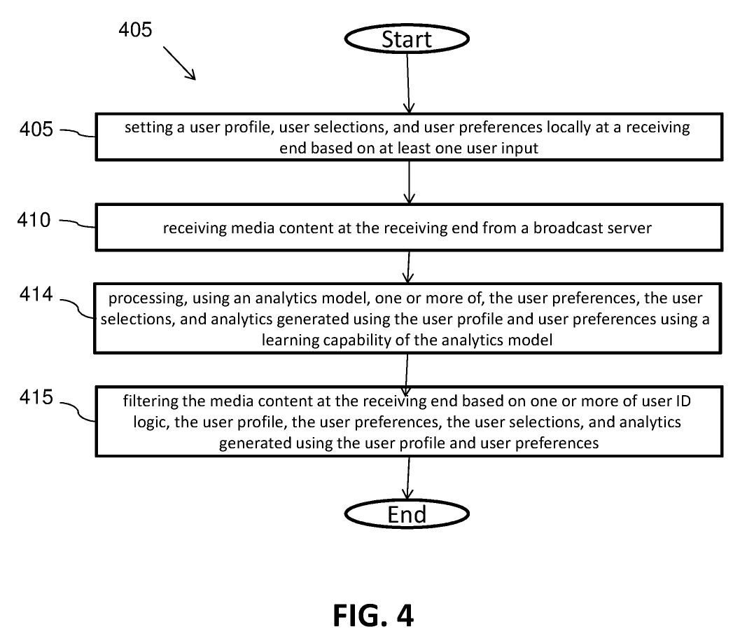

Turning now to FIG. 4, a method of filtering media content is shown in accordance with one or more embodiments. The method includes setting a user profile, user selections, and user preferences locally at a receiving end based on at least one user input (operation 405). The method also includes receiving media content at the receiving end from a broadcast server (operation 410). Additionally, the method includes processing using an analytics model, one or more of, the user preferences, the user selections, and analytics generated using the user profile and user preferences using a learning capability of the analytics model (operation 414). Further, the method includes filtering the media content at the receiving end based on one or more of user ID logic, the user profile, the user preferences, the user selections, and analytics generated using the user profile and user preferences (operation 415).

According to one or more embodiments, the method can be implemented using a system that includes a local filter guided by user preference settings as well as analytical models build from historical media watch records. The local system also includes a local repository that holds media watched by one or more particular user of the local system. The local storage also holds one or more user profiles and preference settings.

According to one or more embodiments, the method can include a user switching on a TV or other display device and/or the user logging into a media source. The method further includes the user being identified. The user can be identified using a login through log in id/password, a thumb impression, or through similar techniques. The system can therefore handle multiple users that can use the same equipment/media. Further, the method includes the local preferred settings being fed to the filtering logic. The method also includes the analytical model also getting the user identification information that is used to pick the right historical model that corresponds to the identified user. Further, the analytical model selects/identifies a user's current context, a time of day, a type of programs, etc., and generates recommendations for selecting the channel or media content. The user preferences and analytical model recommendations are then fed to the smart filtering logic which in turn allows the desired media content to reach the viewer/user while filtering out unselected/undesirable content to not pass through. Further, the system can include equipment that further selects some of the media content that is specific to that equipment. Further, according to another embodiment, the method can further include the ability for the user to optionally override the auto-selection of the media content by the filtering logic.

Further, the method can further include loading information about the selected media content, for example the final watched program information, into the media watch history storage device along with current contextual information. Additionally, according to another embodiment, the analytical model is rerun to account for new information added.

According to one or more embodiments, the user profile includes biographical information about a user, wherein the biographical information includes one or more of a name, an age, a race, a location, a gender, a birthday, an email, and an address of the user. According to another embodiment, the user selections includes at least one user provided command requesting particular media content from the received media content According to another embodiment, the user preferences include one or more of visual preferences, audio preferences, notification preferences, storage preferences, playback preferences, start up preferences, and shut down preferences. According to another embodiment, the user input includes one or more of a command generated by one or more of a touch of a button, a string of characters, an audio command, and a gesture capture from the user.

According to another embodiment, the media content includes at least one or more of a video, music, images, games, and documents. According to another embodiment, the broadcast server provides media content from one or more of a telecommunication provider, a cable provider, a satellite provider, a website, and another user. According to another embodiment, the analytics includes media selections based on local media watch history.

According to another embodiment, receiving media content at the receiving end from a broadcast server further includes requesting media content from the broadcast server based on the user input.

According to another embodiment, receiving media content at the receiving end from a broadcast server further includes receiving media content based on at least one of the user profile and user preferences set locally at the receiving end, wherein the user preferences are set using a set of context specific rule.

The system and method as described herein can be used in a number of different media filtering applications. By way of example, the following general examples of using the system/method are provided to describe specific applications of the system and/or method. Other uses and applications are further envisioned in addition to these examples and therefore these are not meant to limit the system or method but rather are examples only.

A first example, in accordance with one or more embodiments, is the news feed example that includes taste sensitive aggregation. A user initially can subscribe to a news outlet such as XYZ News. Instead of receiving the news all through the day on all different topics, the pull and filter mechanism may be used to pull only according to the user set preferences. For example the user can set out that weather, traffic, and major political/business news can be provided between 7 am to 9 am on weekdays. Further, the user can dictate that no news from 9 to 3 pm on week days be provided. Additionally the user and go on to request that “entertainment and stock market” news be provided between 3 to 7 pm, “sports news” from 7 to 9 pm be filtered by baseball and soccer. Further the user can set the user preferences such that the content only provides 6 headlines-2 from weather/traffic, 2 from business and 2 from politics.

Another example includes context sensitive filtering of Ad emails. In this example a user subscribed to several “Sales promotion Ads” with particular retailers listed such as ABC electronics, DEF apparel, XYZ furniture, and other retailers. The system and method can filter the incoming e-mails by analyzing the contents. For example, the user could select that the system and method show only “Digital Camera” ads for a user that has indicated that they are interested in photography and want to track new technology cameras. Also, the user can select that the system and method filter the incoming media data to show only when “AAA batteries are on sale below $10, when XYZ camera lens is available, and to not show any Ad on food products.

Another example includes a time/day sensitive personalized TV program catalog. The example includes building the dynamic program catalog based on the local filters set up. This example provides the user the ability to see only the media content which the user was interested in at that point in time.

All these examples are distinguishable over server side filtering which amounts to profile-based filtering before pushing the media content information down. Accordingly, the system and method provide a user with the ability to change “view filters” dynamically such that the user can customize the supplied information. According to other embodiments, the media content can include other media types in addition to shows and movies such as eBooks, music, videos, pictures, websites, podcasts, and other known media types.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present invention are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

What is claimed is:

1. A method of media content acquisition and filtering, the method comprising:
setting a user profile, user selections, and user preferences locally at a receiving end based on at least one user input;
receiving media content at the receiving end from a broadcast server; and
processing, using an analytics model, one or more of the user preferences, the user selections, and analytics generated using the user profile and user preferences using a learning capability of the analytics model;
filtering the media content at the receiving end based on one or more of user ID logic, the user profile, the user preferences, the user selections, and analytics generated using the user profile and user preferences.

2. The method of claim 1, wherein the user profile includes biographical information about a user.

3. The method of claim 1, wherein the user selections includes at least one user provided command requesting particular media content from the received media content.

4. The method of claim 1, wherein the user preferences include one or more of visual preferences, audio preferences, notification preferences, storage preferences, playback preferences, start up preferences, and shut down preferences.

5. The method of claim 1, wherein the user input includes one or more of a command generated by one or more of a touch of a button, a string of characters, an audio command, and a gesture capture from the user.

6. The method of claim 1,
wherein the media content includes at least one or more of a video, music, images, games, and documents.

7. The method of claim 1,
wherein the broadcast server provides media content from one or more of a telecommunication provider, a cable provider, a satellite provider, a website, and another user.

8. The method of claim 1, wherein the analytics includes media selections based on local media watch history.

9. The method of claim 1, wherein receiving media content at the receiving end from a broadcast server further comprises:
requesting media content from the broadcast server based on the user input.

10. The method of claim 1, wherein receiving media content at the receiving end from a broadcast server further comprises:
receiving media content based on at least one of the user profile and user preferences set locally at the receiving end, wherein the user preferences are set using a set of context specific rule.

11. A system for media content acquisition and filtering, the system comprising:
a memory having computer readable instructions; and
a processor configured to execute the computer readable instructions, the computer readable instructions comprising:
setting a user profile, user selections, and user preferences locally at a receiving end based on at least one user input;
receiving media content at the receiving end from a broadcast server; and
filtering the media content at the receiving end based on one or more of user ID logic, the user profile, the user preferences, the user selections, and analytics generated using the user profile and user preferences.

12. The system of claim 11, wherein the user profile includes biographical information about a user.

13. The system of claim 11, wherein the user selections includes at least one user provided command requesting particular media content from the received media content.

14. The system of claim 11, wherein the user preferences include one or more of visual preferences, audio preferences, notification preferences, storage preferences, playback preferences, start up preferences, and shut down preferences.

15. The system of claim 11, wherein the user input includes one or more of a command generated by one or more of a touch of a button, a string of characters, an audio command, and a gesture capture from the user.

16. The system of claim 11, wherein the broadcast server provides media content from one or more of a telecommunication provider, a cable provider, a satellite provider, a website, and another user.

17. The system of claim 11, wherein the analytics includes media selections based on local media watch history.

18. The system of claim 11, wherein receiving media content at the receiving end from a broadcast server further comprises:
requesting media content from the broadcast server based on the user input.

19. The system of claim 11, wherein receiving media content at the receiving end from a broadcast server further comprises:
receiving media content based on at least one of the user profile and user preferences set locally at the receiving end, wherein the user preferences are set using a set of context specific rule.

20. A computer program product for media content acquisition and filtering, the computer program product comprising a computer readable storage medium having program instructions embodied therewith, the program instructions executable by a processor to cause the processor to:
set a user profile, user selections, and user preferences locally at a receiving end based on at least one user input;
receive media content at the receiving end from a broadcast server; and
filter the media content at the receiving end based on one or more of user ID logic, the user profile, the user preferences, the user selections, and analytics generated using the user profile and user preferences.
